(19) United States
(12) Patent Application Publication
(10) Pub. No.: US 2012/0170892 A1
(43) Pub. Date: Jul. 5, 2012

(54) OPTICAL FIBER CONNECTOR AND OPTICAL FIBER COUPLING ASSEMBLY HAVING SAME

(75) Inventor: I-THUN LIN, Tu-Cheng (TW)

(73) Assignee: HON HAI PRECISION INDUSTRY CO., LTD., Tu-Cheng (TW)

(21) Appl. No.: 13/113,083

(22) Filed: May 23, 2011

(30) Foreign Application Priority Data
Dec. 31, 2010 (TW) 99147405

(51) Int. Cl. G02B 6/38; G02B 6/36

(52) U.S. Cl. 385/59; 385/77

(57) ABSTRACT

An optical fiber connector includes a connector body, a number of optical lenses, and two receiving holes. The connector body includes a first end face. The optical lenses are arranged at the first end face. The receiving holes are defined in the first end face. The optical lenses are located between the receiving holes. The connector body includes a partially conical inner side surface, a first flat inner side surface, and a second flat inner side surface in each receiving hole. The partially conical inner side surface, the first flat inner side surface, and the second flat inner side surface adjoins each other.

### BACKGROUND

1. Technical Field

The present disclosure relates to optics and, particularly, to an optical fiber connector and an optical fiber coupling assembly having the optical fiber connector.

2. Description of Related Art

An optical fiber coupling assembly is preferred for use in data transmission between electronic devices due to its high transmission speed and signal integrity. The optical fiber coupling assembly includes a first optical fiber connector and a second optical fiber connector coupling optical fibers together to allow optical transmittance between the optical fibers. The first optical fiber connector includes a post. The second optical fiber connector defines a hole conforming to the post. The post and the hole are conic frustum shaped.

In assembly, the post is inserted into the hole so that the two optical fiber connectors are coupled together, and a lens in the first optical fiber connector aligns with a corresponding lens in the second optical fiber connector to ensure the optical transmittance. However, the insertion force is not controllable because of the shapes of the post and the hole. The lens in the first optical fiber connector may deviate from alignment with the optical fiber in the second optical fiber connector. This decreases transmission efficiency and degrades signal integrity.

Therefore, it is desirable to provide an optical fiber connector and an optical fiber coupling assembly having the same, which can overcome or at least alleviate the limitations described.

### BRIEF DESCRIPTION OF THE DRAWINGS

FIG. 1 is a schematic, isometric view of an optical fiber coupling assembly, according to an exemplary embodiment.

FIG. 2 is an exploded view of the optical fiber coupling assembly of FIG. 1.

FIG. 3 is similar to FIG. 2, but viewed from another angle.

### DETAILED DESCRIPTION

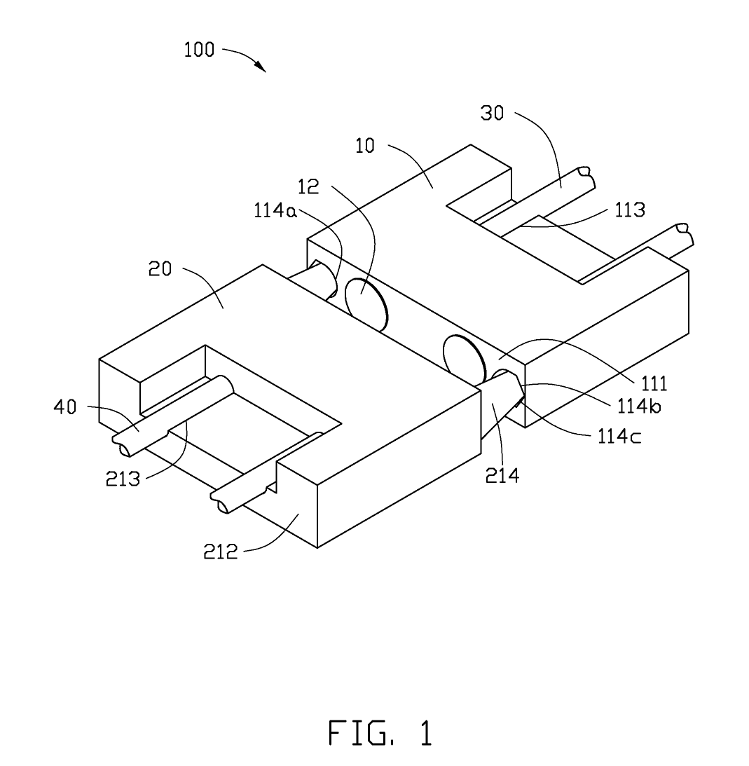

Referring to FIG. 1, an optical fiber coupling assembly 100, according to an exemplary embodiment, includes a first optical fiber connector 10 and a second optical fiber connector 20. The first optical fiber connector 10 couples to the second optical fiber connector 20 to allow optical transmittance.

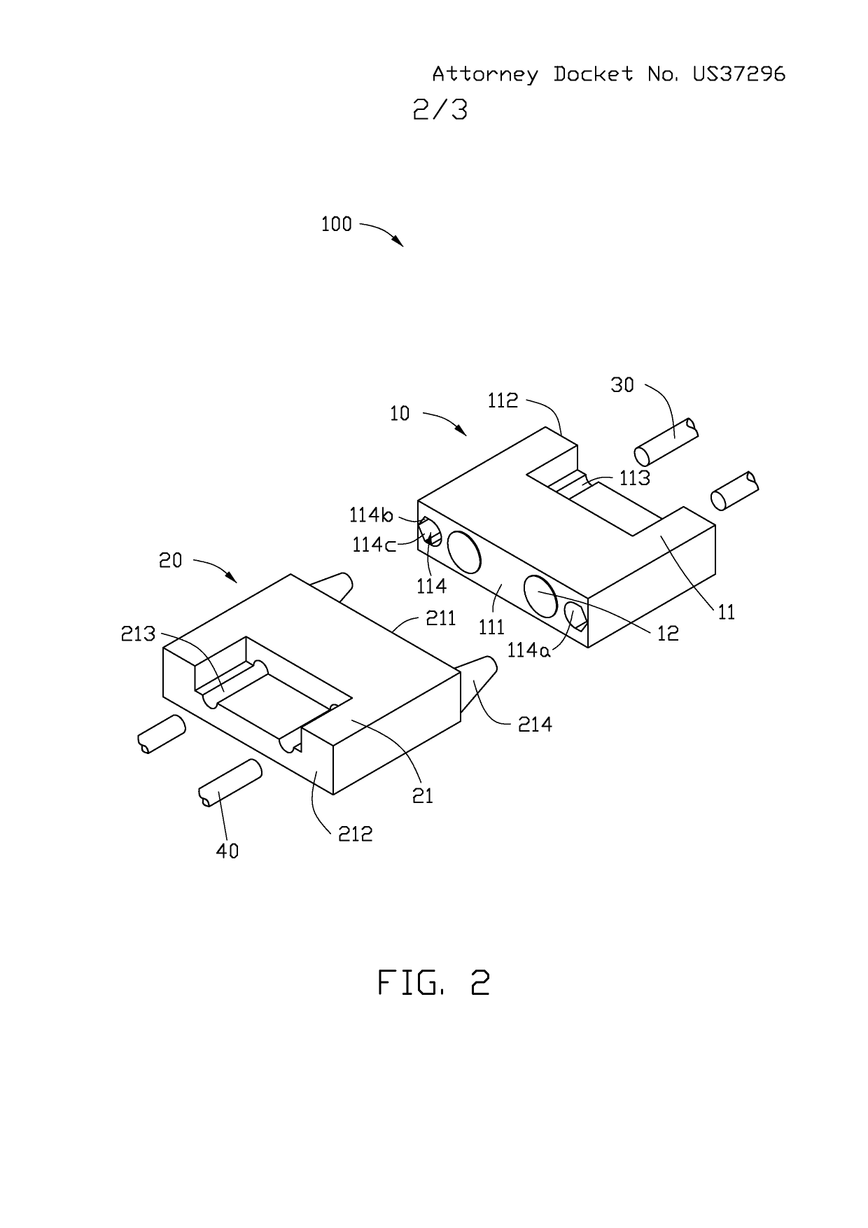

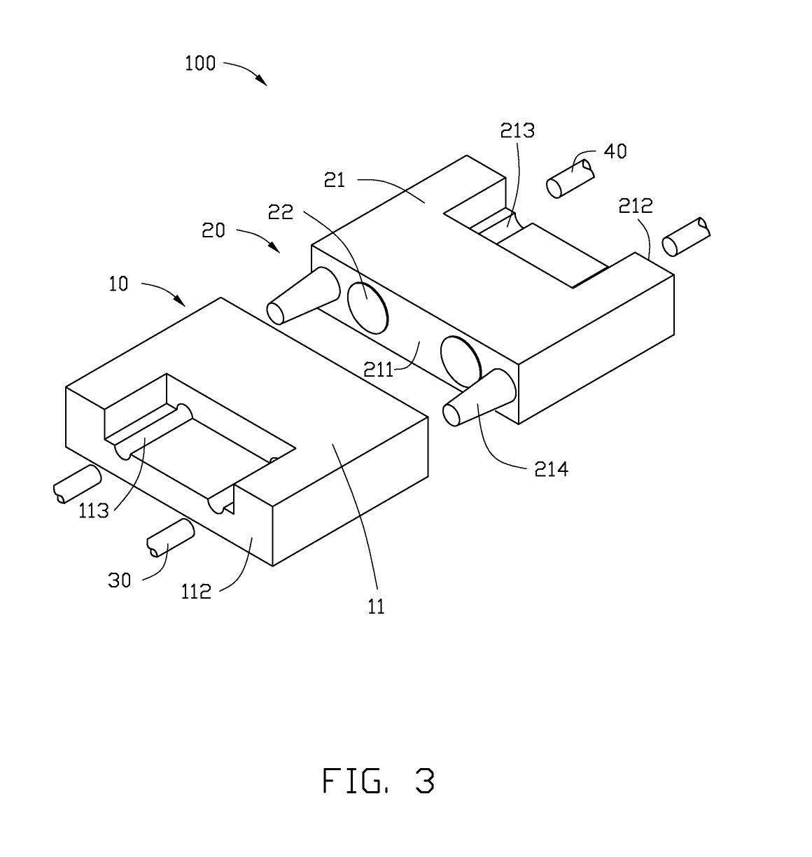

Referring to FIGS. 2-3, the first optical fiber connector 10 includes a first body 11, two first optical lenses 12, and two first optical fibers 30.

The first body 11 is substantially a transparent cube. The first body 11 includes a first end face 111 and a second end face 112. The first end face 111 and the second end face 112 are at opposite sides of the first body 11. The first end face 111 is substantially parallel to the second end face 112. The two first optical lenses 12 are arranged at the first end face 111. Two first grooves 113 are defined in the first body 11. The first grooves 113 extend from the second end face 112 toward the corresponding first optical lenses 12 and terminate in front of the respective first optical lenses 12. In this embodiment, the first optical lenses 12 and the first body 11 are formed as a unitary piece.

The first end face 111 defines two receiving holes 114. The two first optical lenses 12 are located between the two receiving holes 114. Each receiving hole 114 is a blind hole. The first body 11 includes a partially conical inner side surface 114a, a first flat inner side surface 114b, and a second flat inner side surface 114c in each receiving hole 114. The partially conical inner side surface 114a, the first flat inner side surface 114b, and the second flat inner side surface 114c adjoins each other. The partially conical inner side surface 114a is a portion of an inner surface of a cylinder (not shown) and faces away from the first optical lens 12. The partially conical inner side surface 114a is less than or equal to a half portion of the inner surface of the cylinder (not shown). In other words, the central angle of the arc of the partially conical inner side surface 114a is less than or equal to 180 degrees.

The first optical fibers 30 are received in the respective first grooves 113 to align with the respective first optical lenses 12.

The second optical fiber connector 20 includes a second body 21, two second optical lenses 22, and two second optical fibers 40.

The second body 21 is substantially a transparent cube. The second body 21 includes a first side surface 211 and a second side surface 212. The first side surface 211 and the second side surface 212 are at opposite sides of the second body 21. The first side surface 211 is substantially parallel to the second side surface 212. The first side surface 211 faces the first end face 111. The two second optical lenses 22 are arranged at the first side surface 211. Two second grooves 213 are defined in the second body 21. The second grooves 213 extend from the second side surface 212 toward the corresponding second optical lenses 22 and terminate in front of the respective second optical lenses 22. In this embodiment, the second optical lenses 22 and the second body 21 are formed as a unitary piece.

Two posts 214 perpendicularly extend from the first side surface 211 corresponding to the two receiving holes 114. The two second optical lenses 22 are located between the two posts 214. Each post 214 has a conic frustum shape and is matingly engaged with the partially conical inner side surface 114a. The area of the section of the post 214 decreases along a direction away from the first side surface 211. The radius of the largest section of the post 214 is larger than that of the arc of the partially conical inner side surface 114a. The radius of the smallest section of the post 214 is smaller than that of the arc of the partially conical inner side surface 114a.

The second optical fibers 40 are received in the respective second grooves 213 to align with the respective second optical lenses 22.

When the first optical fiber connector 10 is coupled to the second optical fiber connector 20, the posts 214 are inserted into the respective receiving holes 114. The outer wall of each post 214 abuts the partially conical inner side surface 114a in the corresponding receiving holes 114. When the posts 214 are further inserted into the respective receiving holes 114 until the radius of the largest section of each post 214 equals to that of the arc of the partially conical inner side surface 114a, the outer wall of each post 214 simultaneously abuts against the partially conical inner side surface 114a, the first flat inner side surface 114b, and the second flat inner side surface 114c in the corresponding receiving holes 114. Therefore, the two optical fiber connectors 10, 20 are coupled to each other, and the first optical lenses 12 align with the respective second optical lenses 22.

During this process, users have tactile feedback when the outer wall of each post 214 simultaneously abuts against the partially conical inner side surface 114a, the first flat inner side surface 114b, and the second flat inner side surface 114c. Therefore, the insertion force is easily controlled accordingly. The first optical lenses 12 precisely align with the respective second optical lenses 22. This increases transmission efficiency and ensures signal integrity.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An optical fiber coupling assembly comprising:
a first optical fiber connector comprising:
a first body comprising a first end face;
a plurality of first optical lenses arranged at the first end face; and
two receiving holes defined in the first end face, the first optical lenses located between the receiving holes, the first body comprising a partially conical inner side surface, a first flat inner side surface, and a second flat inner side surface in each receiving hole, the partially conical inner side surface, the first flat inner side surface, and the second flat inner side surface adjoining each other; and
a second optical fiber connector comprising:
a second body comprising a first side surface facing the first end face;
a plurality of second optical lenses arranged at the first side surface; and
two posts extending from the first side surface for insertion in the respective receiving holes, the second optical lenses located between the posts, each post having a conic frustum shape, each post configured for engaging with the partially conical inner side surface, the first flat inner side surface, and the second flat inner side surface.

2. The optical fiber coupling assembly as claimed in claim 1, wherein each receiving hole is a blind hole.

3. The optical fiber coupling assembly as claimed in claim 1, wherein each of the partially conical inner side surface faces away from the first optical lenses.

4. The optical fiber coupling assembly as claimed in claim 1, wherein the first and second flat inner side surfaces generally face toward the first optical lenses.

5. The optical fiber coupling assembly as claimed in claim 3, wherein each post is matingly engaged with the partially conical inner side surface.

6. The optical fiber coupling assembly as claimed in claim 1, wherein the first optical fiber connector further comprises a plurality of first optical fibers, the first body further comprises a second end face opposite to the first end face, a plurality of first grooves defined in the first body, the grooves extending from the second end face toward the corresponding first optical lenses, the first optical fibers received in the respective first grooves.

7. The optical fiber coupling assembly as claimed in claim 1, wherein the second optical fiber connector further comprises a plurality of second optical fibers, the second body further comprises a second side surface opposite to the first side surface, a plurality of second grooves defined in the second body, the second grooves extending from the second side surface toward the corresponding second optical lenses, the second optical fibers received in the respective second grooves.

8. An optical fiber connector comprising:
a connector body comprising a first end face;
a plurality of optical lenses arranged at the first end face; and
two receiving holes defined in the first end face, the optical lenses located between the receiving holes, the connector body comprising a partially conical inner side surface, a first flat inner side surface, and a second flat inner side surface in each receiving hole, the partially conical inner side surface, the first flat inner side surface, and the second flat inner side surface adjoining each other.

9. The optical fiber connector as claimed in claim 8, wherein each receiving hole is a blind hole.

10. The optical fiber connector as claimed in claim 8, wherein each of the partially conical inner side surface faces away from the optical lenses.

11. The optical fiber connector as claimed in claim 8, wherein the first and second flat inner side surfaces face toward the optical lenses.

12. The optical fiber connector as claimed in claim 8, further comprising a plurality of optical fibers, wherein the connector body further comprises a second end face opposite to the first end face, a plurality of grooves defined in the connector body, the grooves extending from the second end face toward the corresponding optical lenses, the optical fibers received in the respective grooves.
